(19) United States
(12) Patent Application Publication
(10) Pub. No.: US 2008/0095572 A1
(43) Pub. Date: Apr. 24, 2008

(54) Mechanism for Ring Binder Notebooks

(76) Inventor: Richard Frankeny, Cedar Park, TX (US)

Correspondence Address: FISH & RICHARDSON P.C., P.O BOX 1022, Minneapolis, MN, 55440-1022, US

(21) Appl. No.: 11/573,143

(22) PCT Filed: Aug. 2, 2005
(86) PCT No.: PCT/US05/27346

§ 371 Date: Feb. 2, 2007

Related U.S. Application Data
(60) Provisional application No. 60/598,133, filed on Aug. 2, 2004.

(51) Int. Cl. B42F 3/04; B42F 13/00

(52) U.S. Cl. 402/38; 402/73

(57) ABSTRACT

A ring binder for holding punched paper is configured using two or more curved rotational ring elements (CREs) and corresponding post elements. A linkage mechanism couples the CREs together so that the rotate in unison. When a CRE engages a corresponding post element a ring element is formed for holding punched paper. The interface between the CRE and the post element has features that ensure that the interfaces have minimum gapping and they resist separation in a direction perpendicular to the tangent to the arc of rotation when the rings are closed. The linkage may be latched against rotation. Likewise the interfaces between the CREs and the post elements may be detented to ensure minimum gapping. The mechanism may have features that break the detent before rotation commences. Ring binders with two or more rings may be formed in a variety of sizes.

### TECHNICAL FIELD

The present invention relates in general to ring binder mechanisms for securing and accessing paper in a ring binder notebook.

### BACKGROUND INFORMATION

Notebooks are used in large quantities throughout the world for holding paper that has been edge punched with two or more holes. For ring binder notebooks, each of the two or more holes are fitted over corresponding split rings that have a mechanism for separating apart the split rings at an interface point. Once separated, paper may be added or removed from one of the split rings. When a user is through accessing the paper, a mechanism closes and secures the split rings so the paper will remain within the notebook. Most ring binder notebooks use a ring mechanism that rotationally spreads the rings apart such that each of the split rings remains in the same plane. This ring mechanism has a latching structure that has two stable positions, latched open and latched closed. When sufficient force is applied to spread the rings apart, the mechanism snaps into the open position. Likewise an opposite force, when applied, the mechanism snaps into the closed position. While functional this mechanism is prone to cause injury, requires two handed operation, and is prone to come open. The rings may come open because the force that is applied to the rings by stored paper has a vector component that is the same as the force applied to open the split rings. Newer designs have incorporated a one button mechanism to overcome the requirement to use two hands. However, the mechanism is basically the same with the same deficiencies.

There is, therefore, a need for a new ring binder mechanism that retains the single action operation, has an opening and closing force that is orthogonal to the force applied by store paper, and does not have any snapping action that can cause injury.

### SUMMARY OF THE INVENTION

A ring binder mechanism comprises two or more cylindrical post elements and two or more corresponding curved rotational ring elements (CREs) that when in contact each substantially form a ring shape for holding hole punched paper. Each post element and corresponding curved rotational element contact at an interface that has special features for retaining the post element and curved rotational element engaged until they are released by a secondary action which is used to open and close the ring binder mechanism for accessing and retaining punched paper. The two or more curved rotational elements are coupled together with a linkage that ensures that they all rotate in unison. The (CREs) rotate from a first position where all of the CREs are engaged with a corresponding post element at the interface features. The linkage has a feature that allows it to be latched in the closed position where all the CREs and posts form rings for holding punched paper while allowing the paper pages to be flipped by sliding over the cylindrical cross-section of each engaged post and corresponding CRE. The interface feature on each of the rings prevent the formed rings from being pulled apart. The interface is only released when a CRE is rotated away from its corresponding post element. Since the rotation is orthogonal to the direction of force that acts to pull the rings apart, the ring mechanism of the present invention is more secure than conventional ring binder mechanisms.

In one embodiment of the present invention, the two or more post elements are rigidly mounted to a spring loaded flat rectangular element that allows the post elements to move up and down in a direction parallel to a line through the center and along the length of the post elements. This allows the interface between the post elements and the CREs to be separated and disengaged (in unison) prior to rotating the CREs to open the formed rings of the ring binder mechanism. In this embodiment, the linkage has a slotted section that prevents the rotation of the CREs to start until after the flat rectangular element has been pushed down separating each of the post elements. The linkage then engages the CREs and rotates them to the open position exposing only the posts with any punched paper with holes threaded over the posts. In the open position, paper may be removed or added. To close the ring binder, the linkage is moved in the opposite direction. Features on the linkage again engage the flat rectangular element translating the posts down until the CREs are positioned substantially directly over a corresponding post element. Again the linkage slot disengages the CREs and the features allow the posts to translate up. The interface has mating detent features such that the posts and corresponding CREs are forced into alignment by the spring action of the flat rectangular element.

In another embodiment, the post elements and CREs have the detent features on their side sections such that the post elements do not have to be translated up and down when the linkage rotates the CREs open and closed. In yet another embodiment, the post elements are hollow cylinders that have an internal spring and a ball element. The top of the hollow post elements is sized such that it is slightly smaller that the diameter of the ball element which prevents the ball from escaping while allowing the ball element to be completely depressed into the hollow post element. The tips of the CREs are correspondingly made hollow and shaped to accept the ball element. In this embodiment, when a CRE is rotated into a corresponding post element, the leading edge of the CRE cylinder engages the ball element such that there is a force vector that forces the ball downward into the hollow of the post against the spring. As the ball element moves, the force vector is greater and the ball moves further down into the hollow post element. When the leading edge of the cylinder of the CRE transitions over ½ of the ball element diameter, the ball element starts to come back up into the hollow in the CRE. The action of the spring and the motion of the CRE cause the ball element to act as detent and align the CRE and its corresponding post element. The opening action simply reverses this process. The ball may be made with a flat on the sides perpendicular to the arc of the CRE's motion when it is engaged to the hollow post element. This assures that when a CRE and corresponding mated hollow post element are engaged, a restraining force will be exerted when one tries to pull them apart in a direction perpendicular to the arc of the motion of the CRE at engagement. Punched paper would exert such a force directing to separating a CRE and corresponding hollow post element that are ball detented according to embodiments of the present invention.

In yet another embodiment of the present invention, the CRE and a corresponding mating post element have interface features that lock when a force is applied to pull and engaged CRE and corresponding mating post apart in a direction perpendicular to the arc of motion of the CRE when aligned with its post element. These features have a slight interference to insure a minimum gapping or misalignment at detent.

In one embodiment of the present invention the post elements are fixed to a thin flat metal layer that extends the width of the mechanism and is bent to form a spring segment that acts as a leaf spring. The CREs with their corresponding linkage are assembled into a base element such that the CREs may be rotated in unison within the base element. The linkage and base element aligns the CREs in the correct placement to match with their corresponding posts. The base element is attached to the spring segment so that each CRE aligns with its corresponding mating post element. The spring segment allows the entire CRE assembly to be rotated a few degrees (e.g., 3-5 degrees) so that the CREs transition from engagement with their corresponding post element until their interface is separated allowing the CREs to rotated to allow punched paper to be added or removed from over the post elements. When the CREs are rotated (in unison by the linkage) into alignment with their corresponding post elements, the base element pressed down and a latching element is employed to hold the CREs in engagement with their corresponding post element. When the latch is released, the spring segment automatically rotates the CRE assembly away from their corresponding post element. A user then simply grasps and rotates any one of the CREs and the linkage rotates all the CREs in unison to open the binder mechanism for loading or removing punched paper.

In another embodiment of the present invention, the interface between the CREs and their corresponding post element uses magnets to aid in aligning the CREs and post elements to minimize gapping of the formed rings.

In another embodiment of the present invention, the CREs each have a section with gear teeth concentric with the center of the straight portion of the CRE shafts. A linking element comprises a rectangular gear element that has gear teeth for mating with the gear teeth on the gear sections of the CREs. In this manner, when one of the CREs is rotated that action of the mated gear teeth acts to translate the rectangular gear element. Since the other CREs are mated with the rectangular gear element they are also rotated in unison when any one of the CREs is rotated.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 is an illustration of CREs and post elements in the closed and open positions according to embodiments of the present invention;

FIGS. 2A and 2B illustrate two types of notebooks suitable for practicing embodiments of the present invention;

FIGS. 3A illustrates an interface between a CRE and a post element using a cone section on the CRE and a mating depression on the post element;

FIGS. 3B illustrates a cross-section an interface between a CRE and a post element where the interface features are on the sides of the CRE and the post element wherein the interface features are rotationally engaged.

FIGS. 4 illustrates the cross-section of the interface of FIG. 3B showing the cross-section of a CRE at various angles of rotation according to embodiments of the present invention;

FIGS. 5 illustrates four positions of a CRE and post element with a ball type of interface as the CRE is rotated into engagement with the post element according to embodiments of the present invention;

FIG. 6 illustrates a CRE and post with a ball type interface wherein the ball element has flats on the sides that assure the ball can rotate only in one axis hence providing denting locking according to embodiments of the present invention;

FIG. 7 illustrates two isometric views of a ring binder assembly according to embodiments of the present invention;

FIGS. 8A-8F illustrate various exploded views of the ring binder assembly of FIG. 7;

FIG. 9 illustrates an exploded view of the ring binder assembly of FIG. 7;

FIGS. 10A-10E illustrate various exploded views of the embodiment of FIG. 7;

FIGS. 11A-11E illustrate various exploded views of the embodiment of FIG. 7 showing the rotational positions of the CREs according to embodiments of the present invention;

FIG. 12A illustrates a linkage element according to embodiments of the present invention;

FIG. 12B illustrates a top view of linked CREs and their corresponding post elements when the CREs are rotated to the open position according to embodiments of the present invention;

FIG. 12C illustrates a top view of the linked CREs and their corresponding post elements of FIG. 12B when the CREs are rotated to the closed position according to embodiments of the present invention;

FIG. 13A illustrates a linkage element for a six ring binder mechanism according to embodiments of the present invention;

FIG. 13B illustrates a top view of a six ring linked CREs and their corresponding post elements when the CREs are rotated to the open position according to embodiments of the present invention;

FIG. 13C illustrates a top view of the linked CREs and their corresponding post elements of FIG. 13B when the CREs are rotated to the closed position according to embodiments of the present invention;

FIG. 14 illustrates linked CREs and their corresponding post elements where the interface between the CREs and post elements employ magnets to minimize gapping when the CREs are rotated to the closed position;

FIG. 15A illustrates another ring binder assembly according to embodiments of the present invention;

FIG. 15B illustrates the CRE assembly of FIG. 15A rotated to separate the interface between the CREs and their corresponding post elements;

FIG. 15C is magnified view showing detail of a portion of the ring binder assembly of FIG. 15A;

FIG. 16A is a side view of another ring binder assembly according to embodiments of the present invention employing geared CREs and their linkage element; and

FIG. 16B is a top view illustrating the coupling between the geared CREs and their linkage element in the ring binder assembly of FIG. 16A.

### DETAILED DESCRIPTION

In the following description, numerous specific details are set forth to provide a thorough understanding of the present invention. However, it will be obvious to those skilled in the art that the present invention may be practiced without such specific details. In other instances, well-known mechanisms may be shown in block diagram form in order not to obscure the present invention in unnecessary detail. For the most part, details concerning materials, processes and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

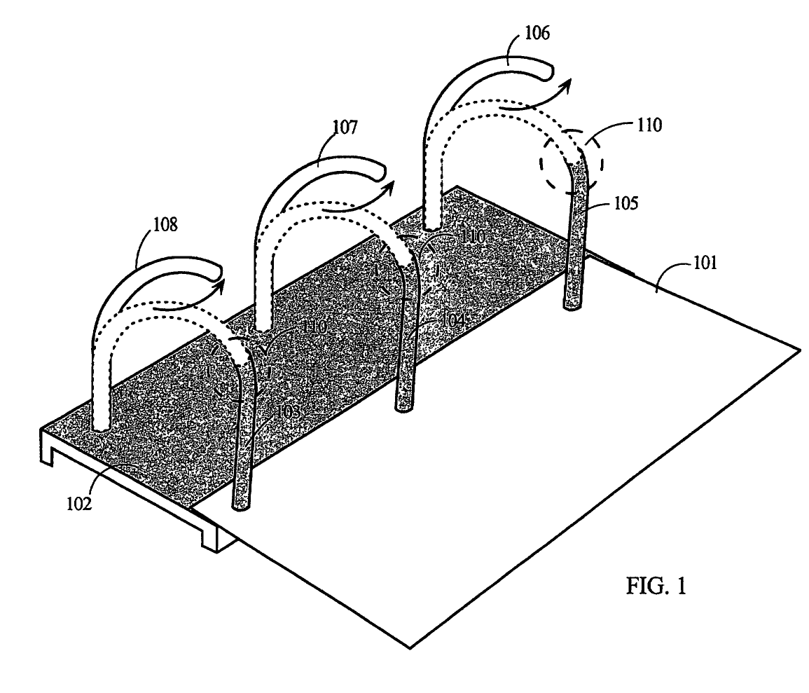

FIG. 1 is a simple view of a three ring binder mechanism according to embodiments of the present invention. A base 102 holds CREs 106-108 and their corresponding post elements 105-103. Each of the CRE/post element pairs have an interface 110 that engages when the CREs are rotated into their closed position. CREs 106-108 may be individually rotated from an open position to a closed position where they engage their corresponding post element. Also a linkage may be used wherein CREs 106-108 are forced to rotate in unison from their open to closed positions. A punched piece of paper 101 is shown with its punched poles placed over a post element.

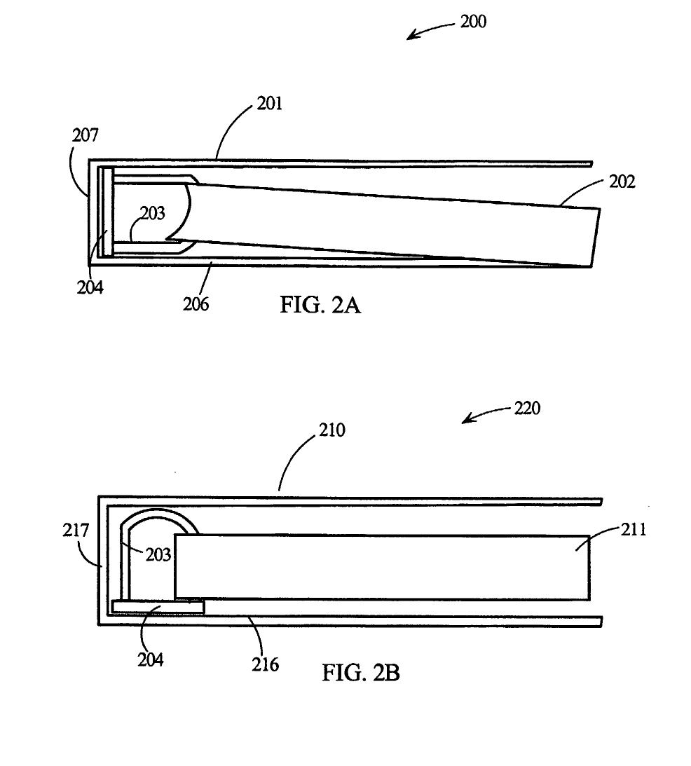

FIG. 2A illustrates one traditional notebook 200 suitable for practicing embodiments of the present invention. Notebook 200 has three cover sections 201, 206 and 207. The base 204 of a ring binder mechanism according to embodiments of the present invention is mounted to section 207. A ring 203 form by a CRE and a corresponding post element is coupled through punched holes of punched paper 202.

FIG. 2B illustrates one traditional notebook 220 suitable for practicing embodiments of the present invention. Notebook 220 has three cover sections 210, 216 and 217. The base 204 of the ring binder mechanism according to embodiments of the present invention is mounted to section 217. A ring 203 form by a CRE and a corresponding post element is coupled through punched holes of punched paper 202. In notebook 220 the ring binder mechanism remains fixed when cover 210 is opened.

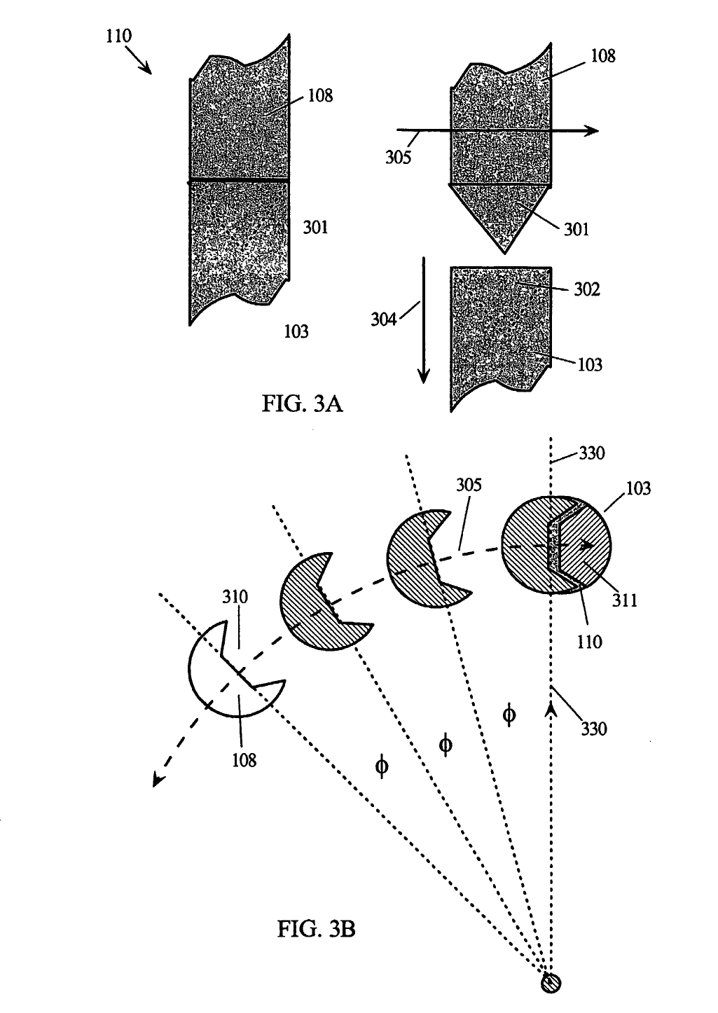

FIG. 3A illustrates interface 110 of one embodiment of the present invention wherein CRE 108 employs a cone section 301 to interface with a corresponding cone shaped depression 302 in post element 103. In this embodiment, post element 103 would first be translated in direction shown by vector 304 to separate cone sections 301 and 302. CRE 108 is then rotated according to embodiments of the present invention in a tangential direction shown as vector 305 at it the CRE's in a closed rotational position.

FIG. 3B is a top section view of another embodiment of the interface 110. In this embodiment post 103 has a side feature 311 wherein a section with a shape substantially like 310 removed from its tip to form a one-half of interface 110. Likewise, CRE 108 has a section with a shape substantially like 310 removed from its tip to form the other half of interface 110. The shape of feature 310 and 311 allow them to “detent” when they come into engagement as CRE 108 rotates into post element 103. When engaged, interface 110 resists forces that act in the direction illustrated by vector 330.

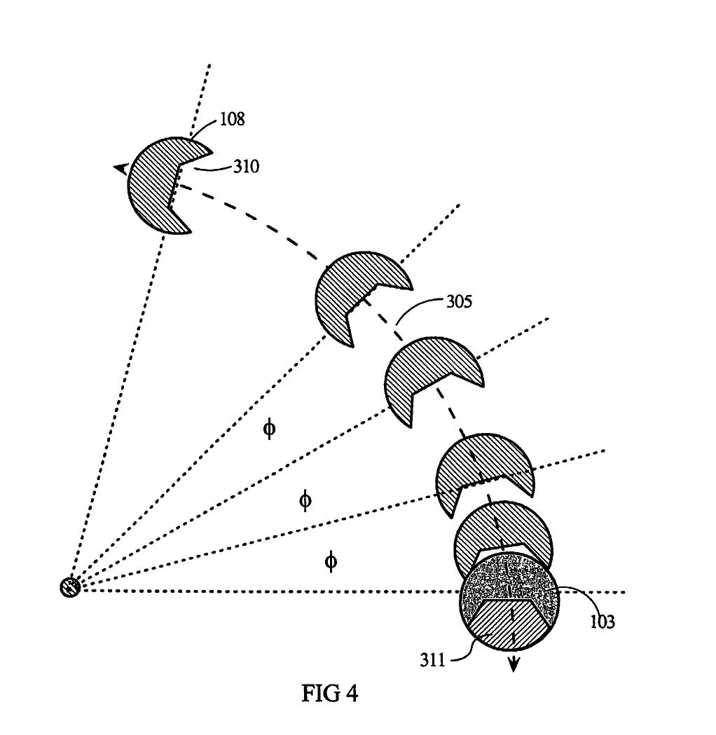

FIG. 4 is another top section view of the embodiment of FIG. 3B showing additional rotational positions of CRE 108 and interface 110 when CRE 108 rotates to engage post element 103 along arc vector 305. Again, the shape of feature 310 and 311 allow them to “detent” when they come into engagement as CRE 108 rotates into post element 103.

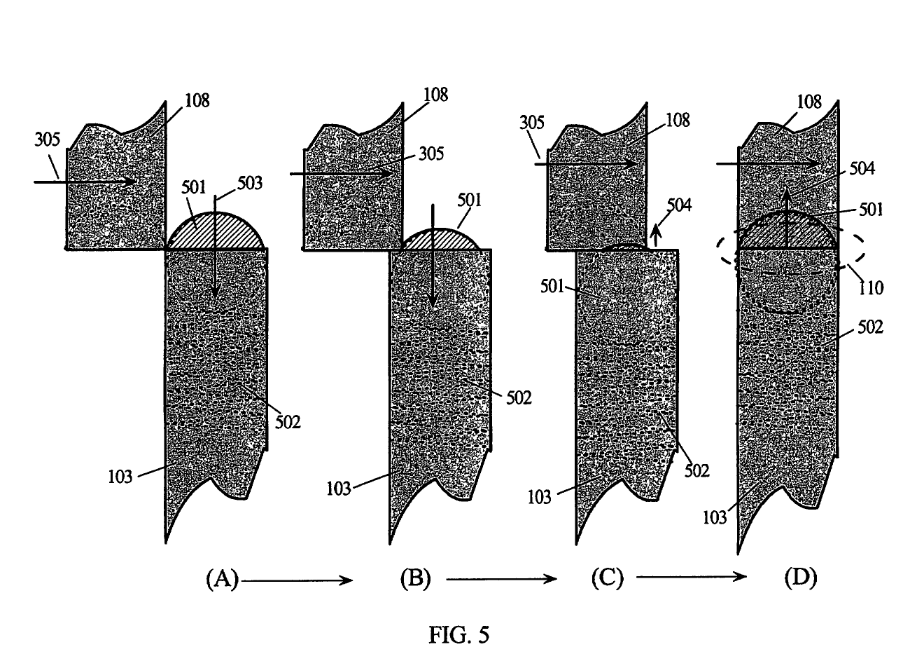

FIG. 5 illustrates a CRE 108 as it engages a post element 103 with a ball and cavity interface 110. Post 103 has a hollow section holding a spring 502 and a ball 501. The tip of post 103 is formed such that it is slightly smaller than the diameter of ball 501, therefore, as spring 502 pushes ball 501 upward its diameter will interfere with the inside diameter of the hollow of post 103 retaining ball 501. As CRE 108 rotates into post 103, the leading edge of the tip of CRE 108 has a force vector directed to push ball 501 downward, in direction 503. The force vector in the direction of vector 305 will cause ball 501 to rotate relieving any side thrust on post 103. The more CRE 108 is rotated into post 103 the greater the force vector becomes in direction 503. In this manner, ball 501 is pressed down into the hollow of post 103. After the leading edge of CRE 108 passes the mid-point of the diameter of post 103, ball 501 starts to move up in the direction 504. When CRE 108 is directly over post 103 the ball 501 is “detented” resisting further rotation of CRE 108 according to embodiments of the present invention. Reversing the rotation of CRE 108 reverses the above process.

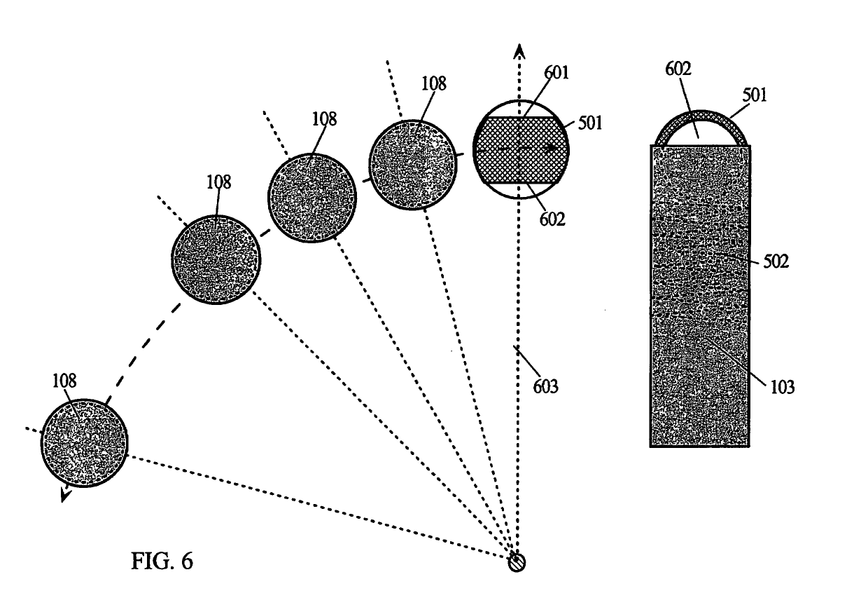

FIG. 6 illustrates a top of the embodiment of FIG. 5 wherein the ball 501 has flats 601 and 602 formed on ball 501. When ball 501 is assembled into post 103, ball 501 can only rotate orthogonal to radial vectors. When CRE 108 and post 103 are engaged at position 603, any force in vector direction 630 can only separate CRE 108 and post 103 is ball 501 is free to rotate in direction 630. If the flats 601 and 602 are in contact with mating flats inside of post 103, ball 501 is not free to rotate in direction 630, thus CRE 108 and post 103 are locked against motion that would try to open their formed ring. In this manner, only rotational force would freely separate CRE 108 and post element 103.

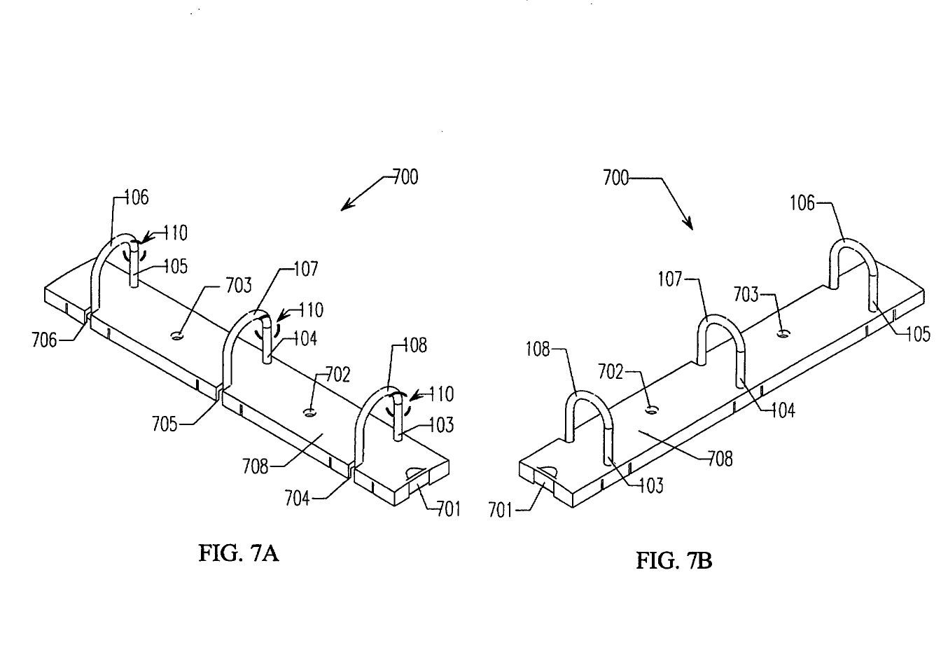

FIG. 7 illustrates two isometric view of a three ring binder assembly according to embodiments of the present invention. CREs 106-108 are engaged with corresponding post elements 105-103 at interfaces 110. A cover 708 is fitted over base 102 (not shown). Slots 704-706 allow cover 708 to be fitted over the base with integrated CREs 106-108. Holes 702-703 are used to attached ring binder assembly 700 to a notebook cover section(e.g., covers sections 204 and 216). The tip of linkage 701 is shown extending from cover 708 allowing a user to rotate the CREs (106-108) according to embodiments of the present invention.

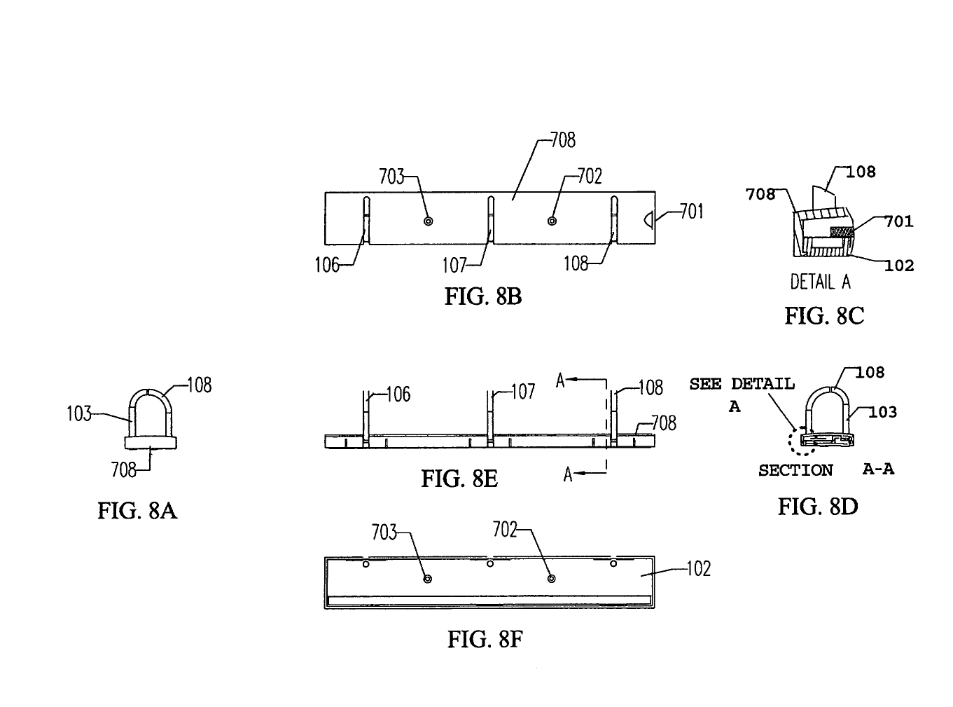

FIGS. 8A-8F illustrate various views of ring binder assembly 700. FIG. 8A is a side view of CRE 108 and corresponding post element 103 with cover 708. FIG. 8B is a top view of ring binder assembly 700 illustrating CREs 106-108, holes 702-703, and a portion of linkage 701. FIG. 8C is a detail of the section (A) view showing cover 708 coupled to base 102 and a portion of CRE 108 and linkage 701. FIG. 8D is the section (A) view illustrating a cross-section of the base assembly and CRE 108 and post element 103. FIG. 8E is a view from the back of assembly 700 showing CREs 106-108 and cover 708 over the base assembly. FIG. 8F is a bottom view of assembly 700 showing holes 702-703 and the bottom of base 102.

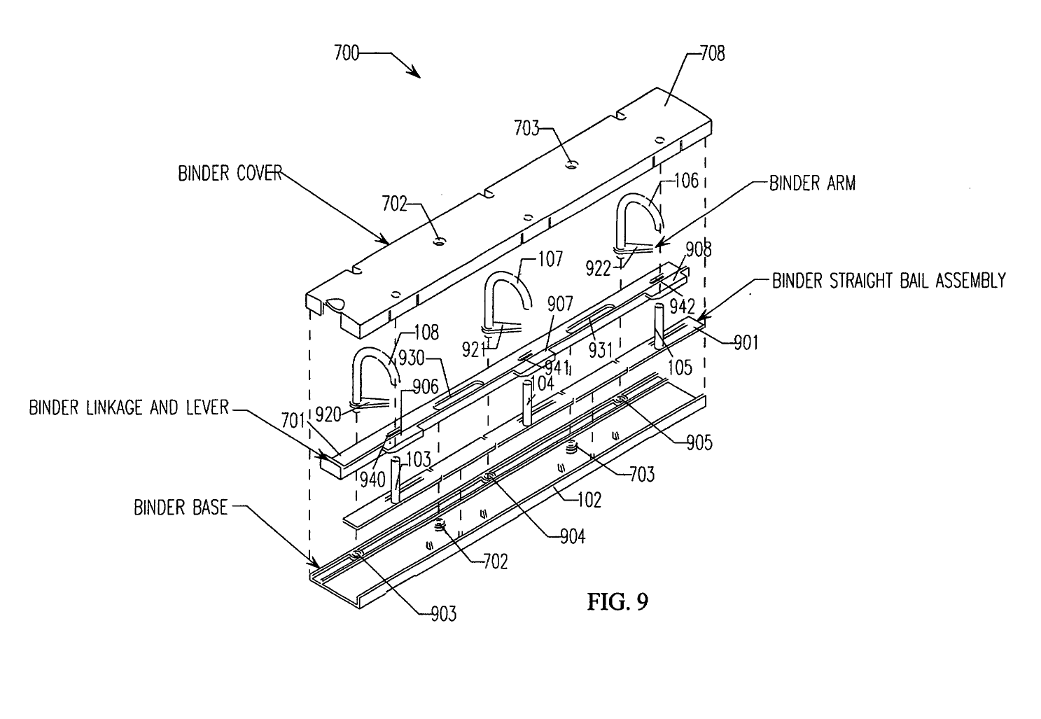

FIG. 9 is an exploded view of assembly 700. Cover 708 has holes 702-703 which extend through the assembly through base 102. CREs 106-108 are shown with their corresponding levers 922-920 that couple with linkage 701 via slots 941-940. Linkage 701 also has cam elements 906-908. Post elements 103-105 are coupled to bail 901 which attaches to base 102.

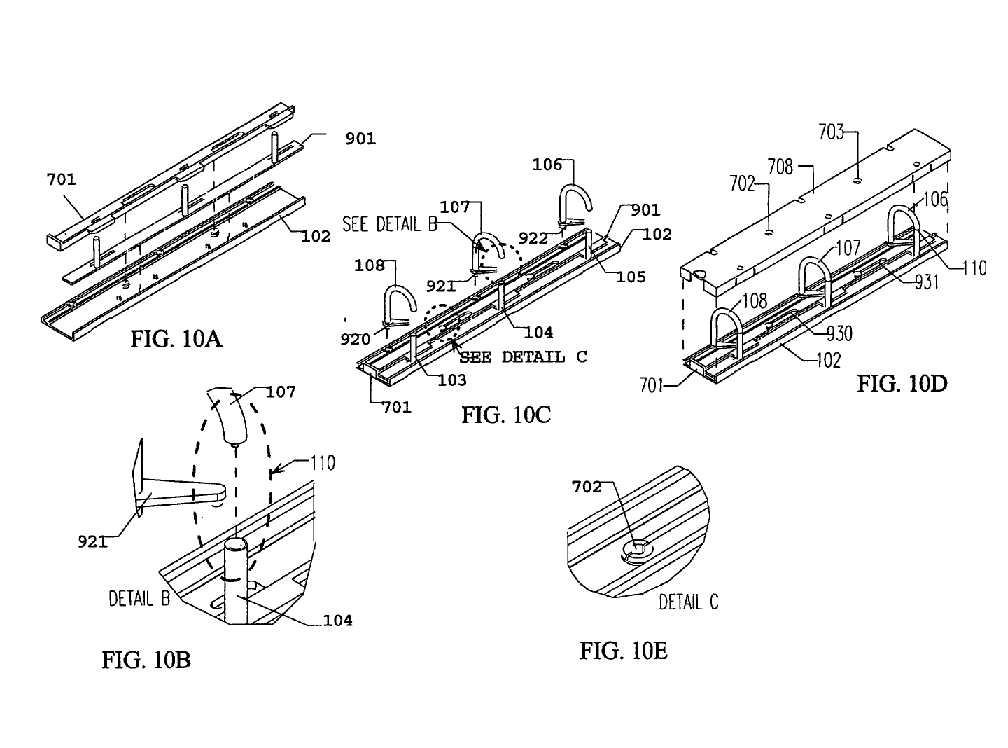

FIG. 10A is an exploded view of a portion of assembly 700 illustrating linkage 701, bail 901 and base 102. FIG. 10B is a detail C showing the interface 110 of post 104 and CRE 107 along with lever 921 on CRE 107. FIG. 10C is an exploded view of CREs 106-108 with their corresponding levers 922-920 and bail 901 with post elements 103-105 coupled into base 102. FIG. 10D is an exploded view of cover 708 with holes 702-703 in position to be place over the base assembly of assembly 700. CREs 106-108 and bail 901 with post elements 103-105 are integrated into base 102. Linkage 701 is shown with clearance slots 930-931 that allow an attachment means (e.g., screw or rivet) for mounting assembly 700 to a note book cover (e.g., 204 and 216 to clear the motion of lever 701 when operated to rotate the CREs open and closed according to embodiments of the present invention. FIG. 10E is a detail of hole 702.

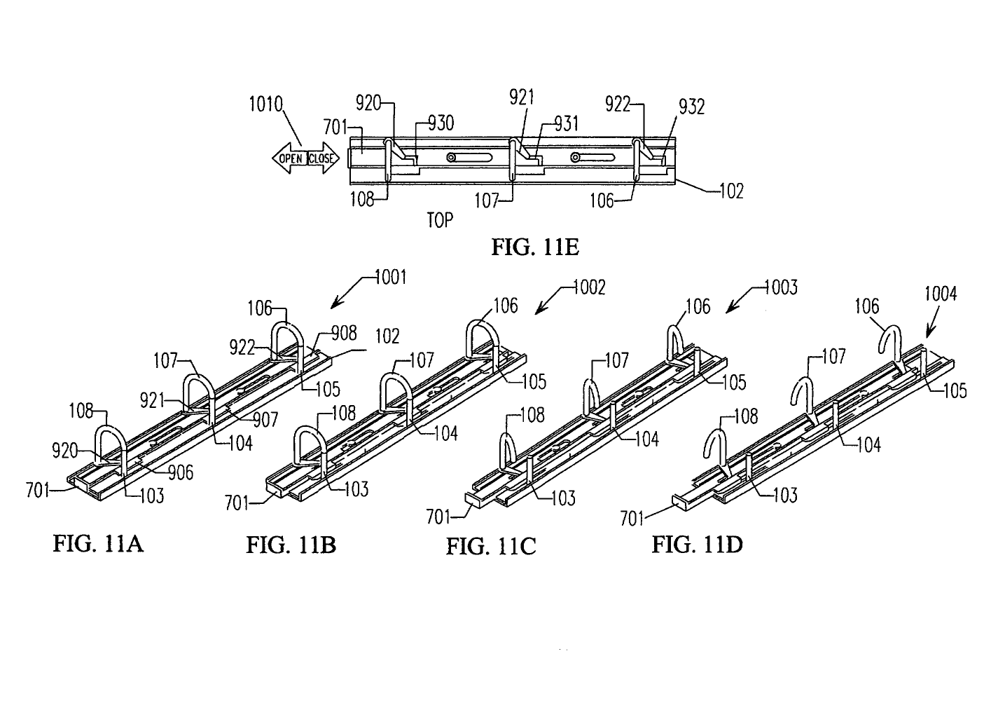

FIGS. 11A-11E illustrate assembly 700 (with cover 708 removed) in various stages of operation according to embodiments of the present invention. FIG. 11A illustrates the CREs (106-108 in the closed position engaging post elements 105-103 respectively. Linkage engaged with levers 921-923 is positioned inside of base 102. In FIG. 11B, linkage 701 is pull out to start the process of opening the rings formed by CREs 106-108 and post elements 105-103. Cams 906-908 are disposed in slots in linkage 701. After linkage 701 is pulled out cams 906-908 engage bail 901 and cause a downward force that flexes bail 901 and resulting in post elements 103-105 translating down separating interfaces 110 positioning the CREs to be rotated. A corresponding slot in linkage 701 allows the levers 920-922 to remain in their home position until posts 103-105 are depressed.

In FIG. 11C, linkage 701 is extended farther and the CREs 106-108 are rotated open away from corresponding post elements 105-103. In FIG. 11D, the CREs 106-108 are rotated completely open. Pushing linkage 701 back into base 102 reverses the process above. The spring force of bail 901 minimizes the gap in the interfaces 110. FIG. 11E is a top view of the assembly 700 with the cover 708 removed showing the open and close motion directions 1010 of linkage 701, CREs 106-108, levers 920-922 and their corresponding slots 930-932.

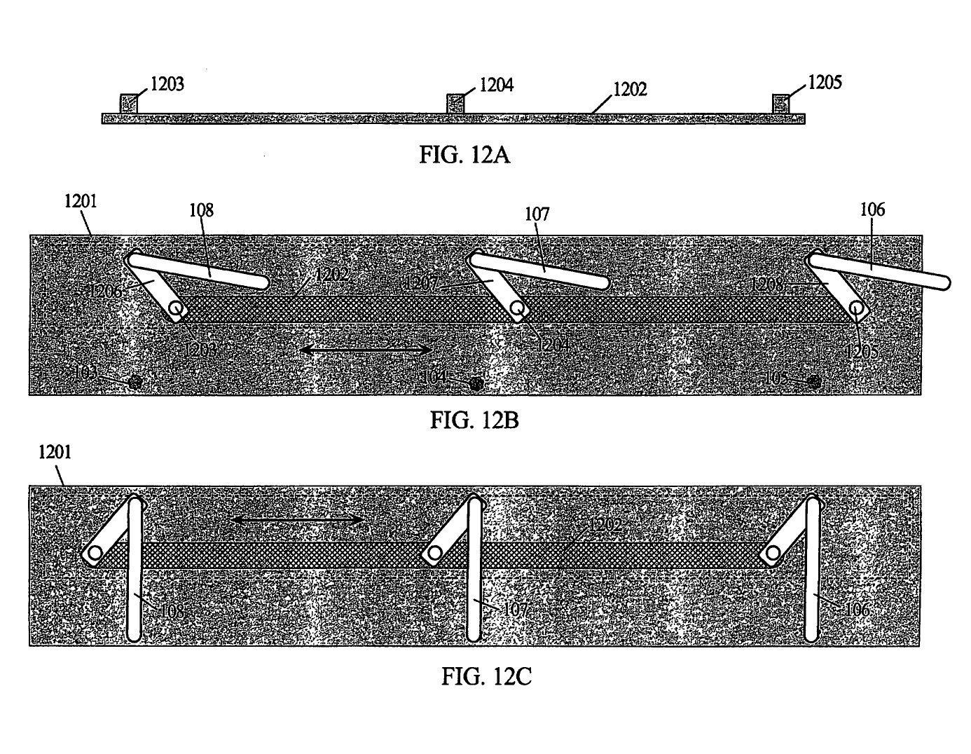

FIG. 12A is a side view of a linkage 1202 according to embodiments of the present invention with corresponding cylindrical elements 1203-1205 that engage corresponding levers 1206-1208 coupled to CREs 108-106. FIG. 12B illustrates base 1202 and linkage 1202 coupled to CREs 108-106 with levers 1206-1208 in the fully open position away from post elements 103-105. FIG. 12C illustrates base 1202 and linkage 1202 coupled to CREs 108-106 with levers 1206-1208 in the fully closed position over post elements 103-105.

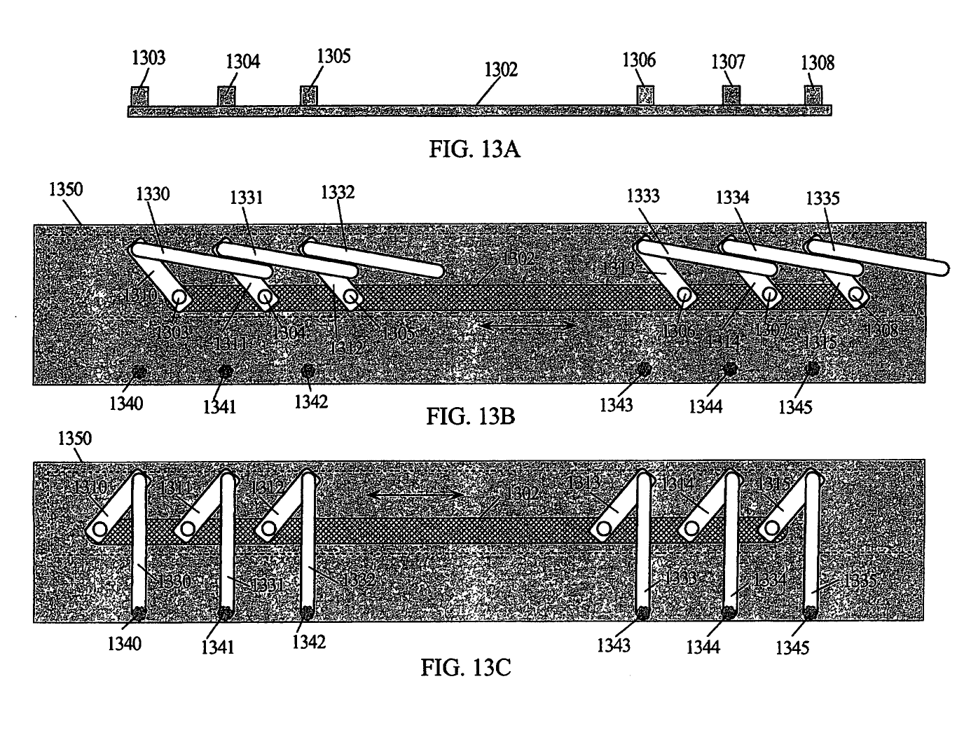

FIG. 13A illustrates a linkage 1302 for a six ring binder mechanism with cylindrical elements 1303-1208 that engage corresponding levers 1310-1315 coupled to CREs 1330-1335 according to embodiments of the present invention. FIG. 13B illustrates base 1350 and linkage 1302 coupled to CREs 1330-1335 with levers 1310-1315 in the fully open position away from post elements 1340-1345. FIG. 13C illustrates base 1350 and linkage 1302 coupled to CREs 1330-1335 with levers 1310-1315 in the fully closed position over post elements 1340-1345.

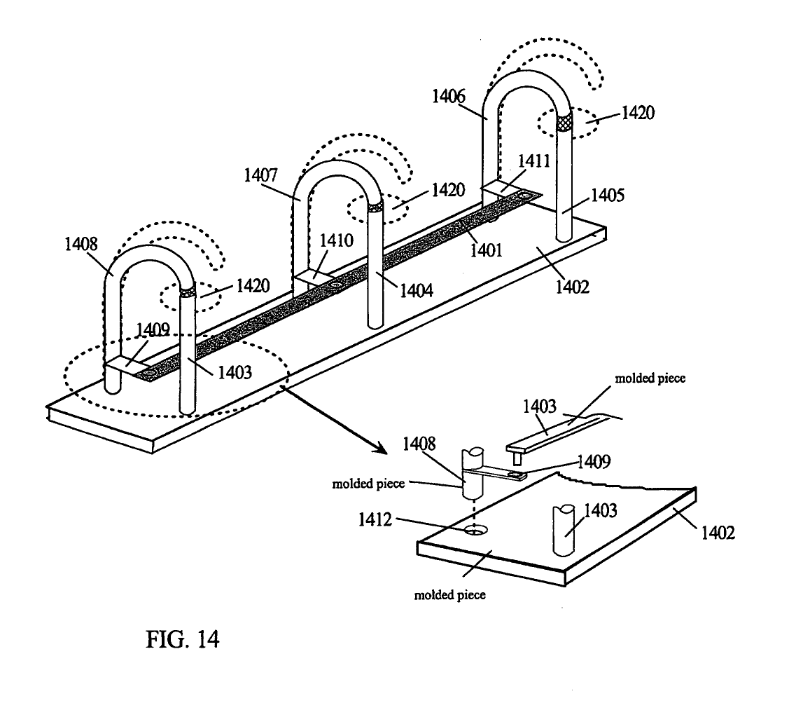

FIG. 14 illustrates another embodiment of the present invention. A base 1402 has fixed post elements 1403-1405 and corresponding CREs 1408-1406 rotationally coupled to base 1402. Levers 1409-1411 are coupled to linkage 1401 that assures the CREs rotate in unison. Interfaces 1420 employ magnets to aid in aligning posts and CREs during closure. The natural detent action of the magnets will pull the tips of the CREs and corresponding posts independently into alignment when they are in a close proximity. By shaping the tips, the only force that freely allows the rings to be opened is the rotational motion of the CREs according to embodiments of the present invention. If the rotary motion is latched, the normal forces that try to pull the rings apart meet with a strong restraining force while the force for opening the rings with rotary motion is only the sheer force of the magnets in the interface. As one magnetic force is broken then the applied force works one fewer magnet for easy opening. FIG. 14 also an exploded view of CRE 1408 with lever 1409 and linkage 1401. Post 1403 is shown in base 1402. A hole 1412 receives the cylinder of CRE 1408 allowing it to rotate while remaining secured in base 1402.

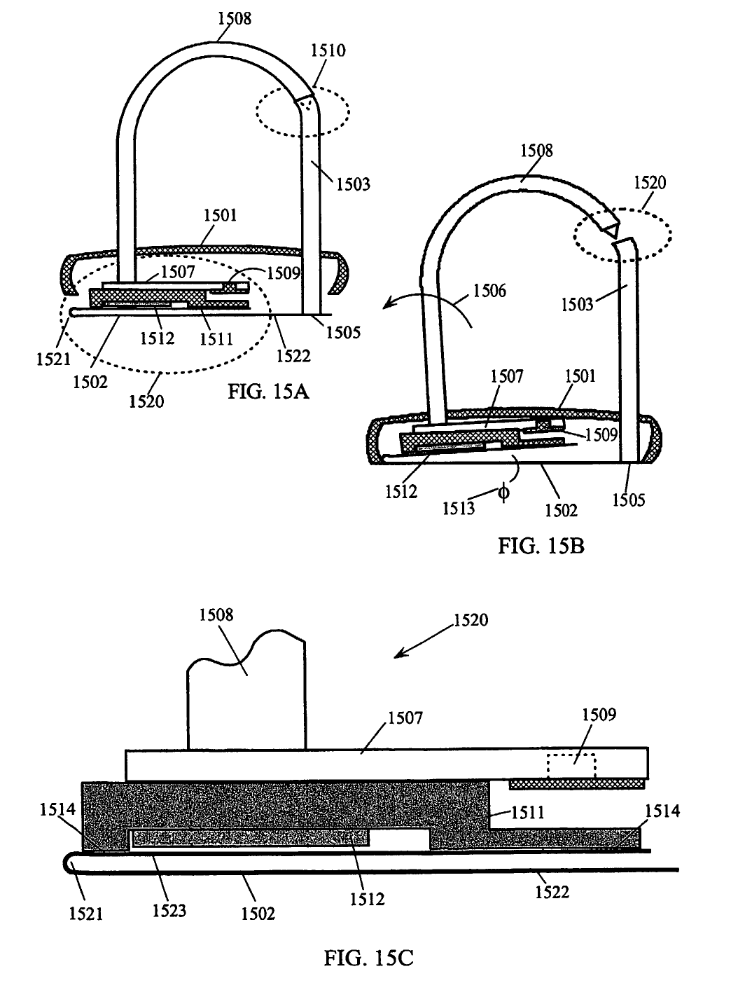

FIGS. 15A-15C illustrate another embodiment of the present invention. In FIG. 15A, a CRE 1508 and corresponding post element 1503 are shown with interface 1510. CRE 1508 is rotationally coupled to base assembly 1520 that is coupled to a spring element 1502. Lever 1507 (e.g., like lever 1206 in FIG. 12) is coupled to the cylinder of CRE 1508 and is coupled to linkage 1509 (like linkage 1202 in FIG. 12. Element 1511 retains CRE 1508 with washer 1512 so that CRE 1508, element 1511, lever 1507, and linkage 1509 are coupled together forming base assembly 1520. A flat spring element 1502 has a flat portion 1522 that extends and rigidly couples to post element 1503 joint 1505) and a leaf spring portion 1523 (see FIG. 15C) that folds over the flat portion 1522 and hinges about bend 1521. Base assembly 1520 is coupled to leaf spring portion 1523 (joint 1514 in FIG. 15C). When leaf spring portion 1523 is free to pivot about bend 1521 it lifts and rotates base assembly 1520 a few degrees and thereby cause the interface 1510 to separate allowing CRE 1508 to be rotated with linkage 1509 and lever 1507 according to embodiments of the present invention. The flat portion 1522 of the spring element may be mounted to a notebook cover (e. g., cover 204 and 216 in FIG. 2) to secure the ring binder mechanism 1500 to the notebook. A cover piece 1501 may be snapped over the edges of the spring element to cover up the mechanism and to present a smooth surface for stored paper coupled to post element 1503. While only one CRE 1508 and post 1503 were shown coupled to base assembly 1520 it is understood that embodiments of the present invention use two or more CREs for normal operation.

FIG. 15B illustrates base assembly and coupled CRE 1508 rotated (vector 1506) an angle 1513 to cause the interface 1510 to separate allowing CRE 1508 to be rotated open according to embodiments of the present invention.

FIG. 15C is an expanded view of base assembly 1520 with coupled CRE 1508. Element 1511 receives the shaft of CRE 1508 and the bottom of lever 1507 contacts its top surface. A washer 1512 is pressed over the shaft of CRE 1508 and contacts a bottom surface of element 1511. This secures CRE 1508 to element 1511 while allowing CRE 1508 to rotate. The surfaces 1514 of element 1511 are attached to leaf spring portion 1523. Linkage 1509 is coupled to lever 1507.

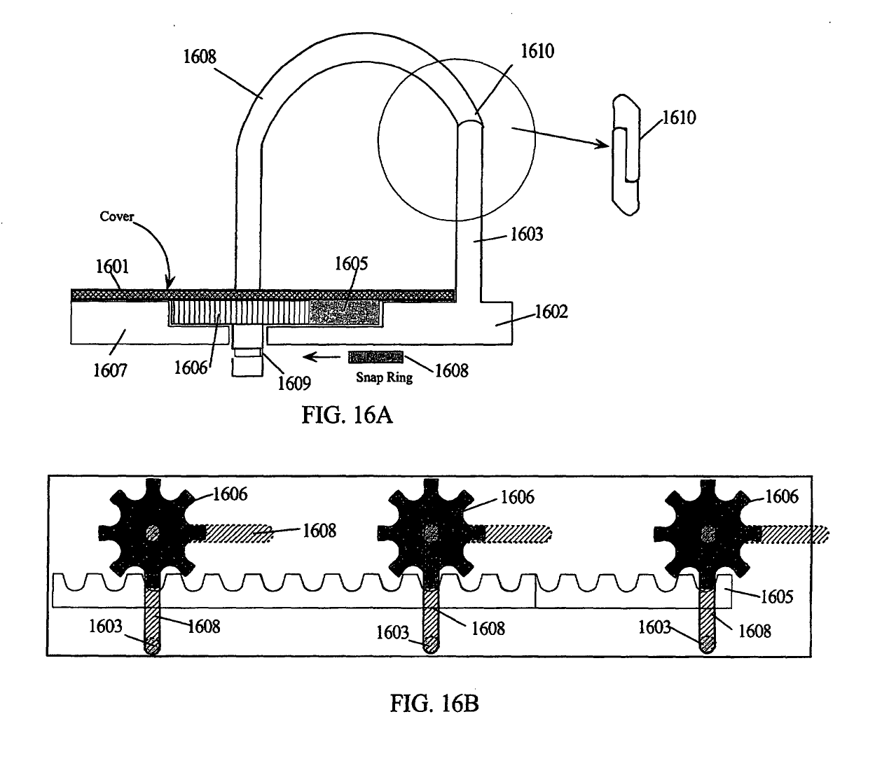

FIG. 16A is a view of a portion of a ring binder mechanism according to another embodiment of the present invention. A base element 1602 has post element 1603. Base element 1602 has a cavity for receiving rectangular geared element 1605 that mates with the gear teeth on the gear portion 1606 of CRE 1608. When geared element 1605 is moved in a direction perpendicular to the page, it acts to rotate CRE 1608. A snap ring 1608 is used to rotationally couple CRE 1608 to base 1602. A cover 1601 is place over the cavity. Interface 1610 is configured so that CRE 1608 and post element 1603 resist separation from forces acting perpendicular to the tangent to the arc of motion of CRE 1608 when rotated.

FIG. 16B is a top view of the ring binder mechanism in FIG. 16A. The gear portions 1606 on multiple CREs 1608 are shown. Multiple mating post elements 1603 are also shown . When geared element 1605 is move laterally, all of the CREs 1608 move in unison according to embodiments of the present invention to rotationally open and close the ring formed by each CRE 1608 and corresponding post element 1603.

The present invention and its advantages have been described in detail, it should be understood that various changes, substitutions and alterations can be made herein without departing from the spirit and scope of the invention as defined by the appended claims.

What is claimed:

1. A ring binder mechanism for holding punched paper in a notebook comprising:
a base element having a width and a length for attaching to a rib section coupling the front and back section of a cover of the notebook;
two or more curved ring elements (CREs) rotationally coupled to the base unit each having a binder arm configured to couple to a linkage such that the two or more CREs rotate in unison when the linkage is translated;
two or more post element corresponding to the two or more CREs each disposed perpendicular to the base unit and space directly opposing the two or more post elements such that they each form a portion of a ring element when a tip of one of the two or more CREs is rotated into contact with a tip of its corresponding post element thereby forming an interface section; and
an actuator portion of the linkage extending from the base unit for translating the linkage to rotate the two or more CREs in unison from a fully open position for accessing the post elements to store or remove punched paper to a fully closed position by engaging the CREs and the post elements at the interface section forming two or more notebook rings for securing the punched paper.

2. The ring binder mechanism of claim 1, wherein the post elements disposed in the base unit by coupling to a bail assembly such that they translate in unison in a vertical direction substantially perpendicular to the base unit an amount sufficient to disengage from the CREs at the interface section.

3. The ring binder mechanism of claim 2, wherein the bail assembly is configured to engage the linkage to vertically translate the post elements substantially perpendicular to the base unit to disengage them from the CREs before the linkage engages the binder arms on the CREs to rotate the CREs from a fully closed position.

4. The ring binder mechanism of claim 3, wherein the linkage is configured to engage a portion of the bail assembly when at its fully closed position to hold the post elements locked in engagement with CREs.

5. The ring binder mechanism of claim 1, wherein the CREs are coupled to the base unit with a spring loaded element extending substantially the length of the base unit that pivots the CREs in unison in a vertical plane parallel to a vertical axis of the post elements by an amount sufficient to disengage each CRE from its corresponding post element.

6. The ring binder mechanism of claim 5, wherein the spring loaded element is coupled to the linkage and configured such that the linkage engages a portion of the spring loaded element and pivots the CREs in the vertical plane an angular distance sufficient to disengage from the post elements before the linkage engages the binder arms that rotates the CREs from a fully closed position.

7. The ring binder mechanism of claim 6, wherein the linkage is configured to engage a portion of the spring loaded element to hold the CREs locked in engagement with post elements when at its fully closed position.

8. The ring binder mechanism of claim 1, wherein the interface section comprises a feature on the tip each CRE that engages and couples to the tip of its corresponding post element.

9. The ring binder mechanism of claim 8, wherein the feature on the tip of each CRE is a cone and the feature on the tip of each post element is a mating cone shaped depression.

10. The ring binder mechanism of claim 8, wherein the feature on the tip of each CRE is a spring loaded ball section captured with a flange in a hollow of each CRE such that less that one half of the ball section extends from the hollow of each CRE and the feature on the tip of the post element is a mating hollow section.

11. The ring binder mechanism of claim 10, wherein the ball section compresses the spring when the CRE is rotated in an arc tangential to the tip of the post element perpendicular to a vertical plane of the post element and the ball section retains engagement with the post element against forces directed to rotate the post element in the vertical plane.

12. The ring binder mechanism of claim 1, wherein interface section comprises a feature on a tip of each CRE that is one half of a ball and socket coupling system and a feature on a tip of each of the post elements that is a mating half of the ball and socket coupling system, the ball and socket coupling system configured to detent each CRE and its corresponding post element when they are rotated into alignment by the linkage and translated into engagement by the bail assembly.

13. The ring binder mechanism of claim 6, wherein interface section comprises a feature on a tip of each CRE that is one half of a ball and socket coupling system and a feature on a tip of each of the post elements that is a mating half of the ball and socket coupling system, the ball and socket coupling system configured to detent each CRE and its corresponding post element when they are rotated into alignment by the linkage and pivoted into engagement by the spring loaded element.

14. The ring binder mechanism of claim 1 further comprising a cover element that clips over the base unit with clearances for the CREs and the post elements.

15. The ring binder mechanism of claim 1, wherein the notebook rings are U-shaped.

16. A notebook for holding punched paper comprising:
a cover having a front section, a back section and a rib section coupling the front and back section forming the notebook, the rib section having a length and a width, the width setting a capacity of punched paper retained in the notebook;
a ring binder mechanism forming notebook rings extending through holes in the punched paper, the ring binder mechanism having a base element having a width and a length for attaching to a rib section coupling the front and back section of a cover of the notebook, two or more curved ring elements (CREs) rotationally coupled to the base unit each having a binder arm configured to couple to a linkage such that the two or more CREs rotate in unison when the linkage is translated, two or more post element corresponding to the two or more CREs each disposed perpendicular to the base unit and space directly opposing the two or more post elements such that they each form a portion of a ring element when a tip of one of the two or more CREs is rotated into contact with a tip of its corresponding post element thereby forming an interface section, and an actuator portion of the linkage extending from the base unit for translating the linkage to rotate the two or more CREs in unison from a fully open position for accessing the post elements to store or remove punched paper to a fully closed position by engaging the CREs and the post elements at the interface section forming two or more notebook rings for securing the punched paper.

17. The notebook of claim 16, wherein the post elements disposed in the base unit by coupling to a bail assembly such that they translate in unison in a vertical direction substantially perpendicular to the base unit an amount sufficient to disengage from the CREs at the interface section.

18. The notebook of claim 17, wherein the bail assembly is configured to engage the linkage to vertically translate the post elements substantially perpendicular to the base unit to disengage them from the CREs before the linkage engages the binder arms on the CREs to rotate the CREs from a fully closed position.

19. The notebook of claim 18, wherein the linkage is configured to engage a portion of the bail assembly when at its fully closed position to hold the post elements locked in engagement with CREs.

20. The notebook of claim 16, wherein the CREs are coupled to the base unit with a spring loaded element extending substantially the length of the base unit that pivots the CREs in unison in a vertical plane parallel to a vertical axis of the post elements by an amount sufficient to disengage each CRE from its corresponding post element.

21. The notebook of claim 20 wherein the spring loaded element is coupled to the linkage and configured such that the linkage engages a portion of the spring loaded element and pivots the CREs in the vertical plane an angular distance sufficient to disengage from the post elements before the linkage engages the binder arms that rotates the CREs from a fully closed position.

22. The notebook of claim 21, wherein the linkage is configured to engage a portion of the spring loaded element to hold the CREs locked in engagement with post elements when at its fully closed position.

23. The notebook of claim 16, wherein the interface section comprises a feature on the tip each CRE that engages and couples to the tip of its corresponding post element.

24. The notebook of claim 23, wherein the feature on the tip of each CRE is a cone and the feature on the tip of each post element is a mating cone shaped depression.
